(19) United States
(12) Patent Application Publication
(10) Pub. No.: US 2011/0042410 A1
(43) Pub. Date: Feb. 24, 2011

(54) POURING PACKAGE AND POURING MEMBER

(75) Inventor: Thomas Gijsbert Paulen, Eindhoven (NL)

Correspondence Address: YOUNG & THOMPSON, 209 Madison Street, Suite 500, Alexandria, VA, 22314, US

(73) Assignee: WEASY PACK INTERNATIONAL LTD., Labuan F.T., Labuan (MY)

(21) Appl. No.: 12/863,446

(22) PCT Filed: Jan. 16, 2009
(86) PCT No.: PCT/NL09/50018

§ 371 Date: Nov. 2, 2010

(30) Foreign Application Priority Data
Jan. 18, 2008 (NL) 2001201

(51) Int. Cl. B67D 1/00; B67D 3/00

(52) U.S. Cl. 222/81; 222/83; 222/528; 222/530

(57) ABSTRACT

A pouring package for a liquid comprises an at least substantially liquid-tight container (10) with an outflow opening (15) in a wall surface (11) thereof. At the position of the opening (15) a pouring member (30) is arranged with an outlet (33) on a distal outer end thereof at which a liquid can exit the product space. In a closed position the pouring member extends at least substantially flat against the wall surface. At least a distal outer end of the pouring member can be erected into a ready-to-use position.

The present invention relates to a pouring package for a liquid, comprising an at least substantially liquid-tight container with an outflow opening in a wall surface thereof, where a pouring member is arranged with an inlet which, at least in a ready-to-use situation, is in open communication with a product space in the container, and with an outlet on a distal outer end thereof at which a liquid can exit the product space. The invention also relates to a pouring member for use with a pouring package. Within the scope of the present invention the term “pouring” should be broadly interpreted such that it is understood to mean not only pouring from one container into another, but should also be understood to mean, among other possibilities, an optionally forced emission under pressure or sucking of the liquid, unless the text or context expressly indicates otherwise.

A package of the type described in the preamble is applied on a large scale in the food industry for the purpose of packaging for instance soft drinks, fruit juices and dairy products. Such a package is however also suitable for all manner of other liquids as well as drinks. This is normally a container which is assembled largely from cardboard, has a usually rectangular section, is provided on an inner side with a liquid-tight coating and has been filled with the liquid in an automated process. In order to enhance pouring from the package a pouring member is provided on a top side thereof in a wall surface, with which member the liquid can be poured after breaking of a breakable side. A volume of the package can vary here typically from between 200 millilitres to 500 millilitres for portion packs to 1, 1½ or even more than 2 litres for larger volume packages. In the case of said portion packs a pouring member is often supplied separately in the form of a straw which must here be inserted into the outflow opening by the user him/herself.

A drawback of the existing pouring packages is that the fixed pouring members applied therein are not usually very user-friendly and protrude relatively far out of the wall surface, which can disrupt the processing in an automated process. A drawback of a separately supplied pouring member is on the other hand the additional assembly and the limited convenience of use.

The present invention has for its object, among others, to provide a pouring package which obviates one or more of these drawbacks to an at least significant extent.

In order to achieve the stated object a pouring package of the type described in the preamble has the feature according to the invention that at the position of the outflow opening the pouring member is connected liquid-tightly to an adjacent part of the wall surface, that in a closed position the pouring member is fixed at least substantially flat against the wall surface, and that at least the distal outer end of the pouring member can be erected into the ready-to-use position. The fixedly connected pouring member thus has a relatively flat profile with the wall surface in the closed storage position, but can be erected therefrom to provide the intended convenience of pouring.

In a particular embodiment the pouring member according to the invention is characterized in that the pouring member comprises a sleeve-like body with a flexible wall and that attaching means are provided with which the sleeve-like body, at least in the closed position, is attached at least substantially flat against the wall surface. In the closed position the sleeve-like pouring member, which may or may not be wholly cylindrical, is here bent back against the wall surface and attached thereto, but can be removed relatively easily from the wall surface and erected so as to take up a ready-to-use position. The flexible wall here allows an exceptionally flat profile with the wall surface.

A preferred embodiment of the pouring package herein has the feature according to the invention that the attaching means comprise an adhesive foil under which the flexible body is received in a substantially flat position, wherein the adhesive foil extends beyond the flexible body and adheres to an adjacent part of the wall surface. The foil here not only provides the desired adhesion, but also covers the pouring member with the outlet in hygienic manner. Use can be made here of an adhesive foil which is wholly released from the package when the package is opened, although a further preferred embodiment of the pouring package according to the invention has the feature that a peripheral part of the foil is connected permanently to the container and the other part adheres semi-permanently to the wall surface. The foil herein remains adhered to the package, this avoiding the possibility of the foil being discarded separately into the environment and moreover enabling reclosure of the package. In order to avoid an adverse interaction between liquid and adhesive layer, a further particular embodiment of the package according to the invention herein has the feature that the attaching means comprise a foil sleeve into which the pouring member protrudes with at least a distal outer end, wherein an underside of the foil sleeve adheres to the wall part. The outlet of the pouring member is thus enclosed in the sleeve and remains separated from the adhesive layer.

Such a sleeve-like pouring member is not only suitable for pouring in the strict sense of the word, but also highly suitable for sucking of the liquid out of the container, particularly in the case of a portion pack. In order to avoid the pouring member here being pressed completely flat and closing, a further particular embodiment of the pouring package according to the invention is characterized in that the body comprises an inner wall which is profiled in a first direction on a first side and profiled in a second, different direction on an opposite side. The profiles extending in mutually differing directions ensure an open liquid path through the pouring member during use.

The sleeve-like body is preferably formed integrally from a suitable plastic, for instance by thermoforming or extrusion. Many plastics are suitable for this purpose, although polyethylene, polystyrene, polycarbonate or PET are recommended.

A further preferred embodiment of the pouring package according to the invention has the feature that the pouring member comprises an at least substantially form-retaining pouring body with a hollow pouring spout which is arranged pivotally relative to a base part thereof and which comprises the outlet, that the base part is connected adjacently of the outflow opening to the wall surface of the container and comprises the inlet, and that the base part comprises closing means which are able and adapted to enter into co-action with the pouring spout in order to effect a reclosable snap connection therebetween. The pouring member is here form-retaining and can be pivoted at least partially outward from the wall surface. In the closed position the pouring member thus retains a relatively flat profile. The closing means provide for a practical reclosability of the container. In a particular embodiment the pouring package according to the invention is characterized here in that the closing means comprise an edge part of the base part with a shoulder which is directed toward the pouring spout and under which snaps a distal outer end of the pouring spout in the closed position.

The pouring member of such a package can be arranged beforehand as well as afterward, following filling of the package. In the first case a particular embodiment of the pouring package according to the invention has the feature that the pouring member is attached against an inner side of the wall part and protrudes with the base part through the outflow opening. The outflow opening is here closed only by the pouring member, which can for instance be provided for this purpose with an additional hermetic breakable closure over the outlet.

For a smooth integration into existing sterile filling processes such as frequently occur in the food industry, a further preferred embodiment of the pouring package according to the invention has the feature that the outflow opening is hermetically closed with a breakable closure and that the pouring member is arranged over the breakable closure on an outer side of the wall part. The breakable closure thus already provides for a hermetic and airtight closure of the container during filling of the package and, if desired, the pouring member can be arranged only after filling.

In a particularly practical embodiment the pouring package according to the invention is characterized here in that the base part of the pouring member opposite the breakable closure comprises a wall, from which extends at least one perforating member directed toward the breakable closure, wherein the at least one perforating member is able and adapted to break through the breakable closure under the influence of a pressure applied externally to the wall. The breakable closure can thus be broken from outside in order to release the liquid to the pouring member. A further perforating member herein forces for instance a venting opening in the breakable closure.

In order to enhance smooth pouring from the container a further preferred embodiment of the package according to the invention has the feature that the base part comprises a venting opening and that from the pouring spout there extends a closing member which is able and adapted to enter the venting opening fittingly in the closed position of the pouring spout. A further particular embodiment of the pouring package has the feature here that the closing member comprises a protrusion which snaps into the venting opening, wherein the closing member also provides for reclosability of the pouring member.

The invention will now be further elucidated on the basis of several exemplary embodiments and an accompanying drawing. In the drawing:

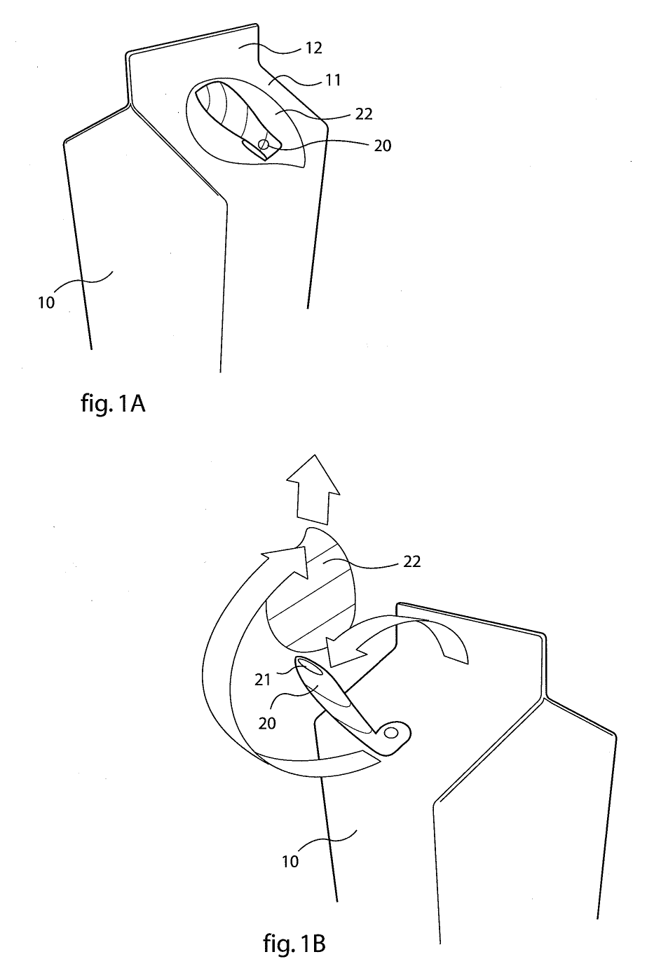

FIGS. 1A-1B show perspective views of a first embodiment of the pouring package according to the invention in respectively closed and opened position;

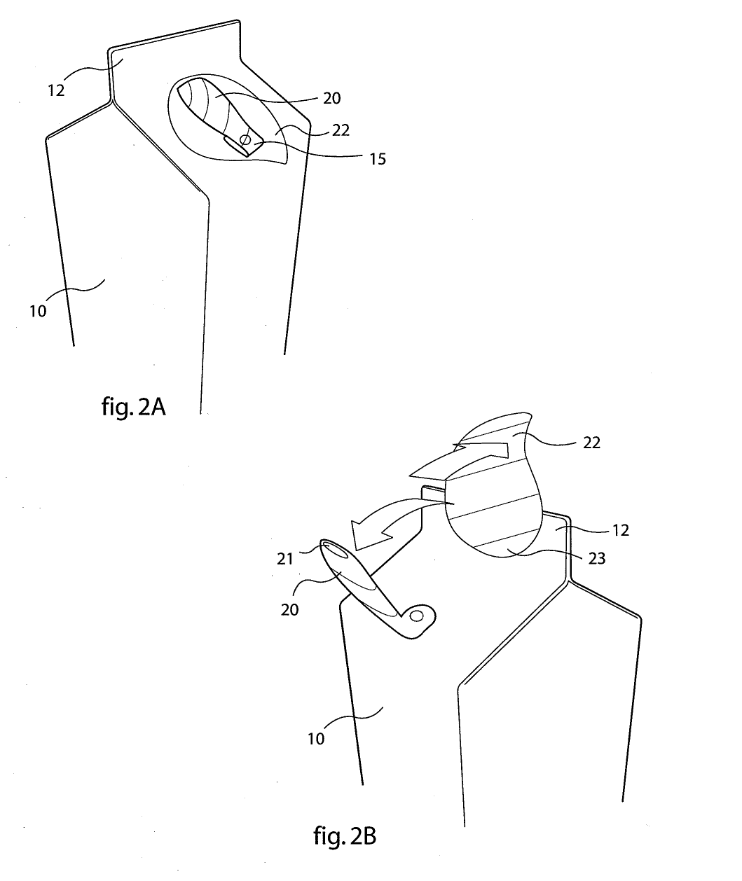

FIGS. 2A-2B show perspective views of a second embodiment of the pouring package according to the invention in respectively closed and opened position;

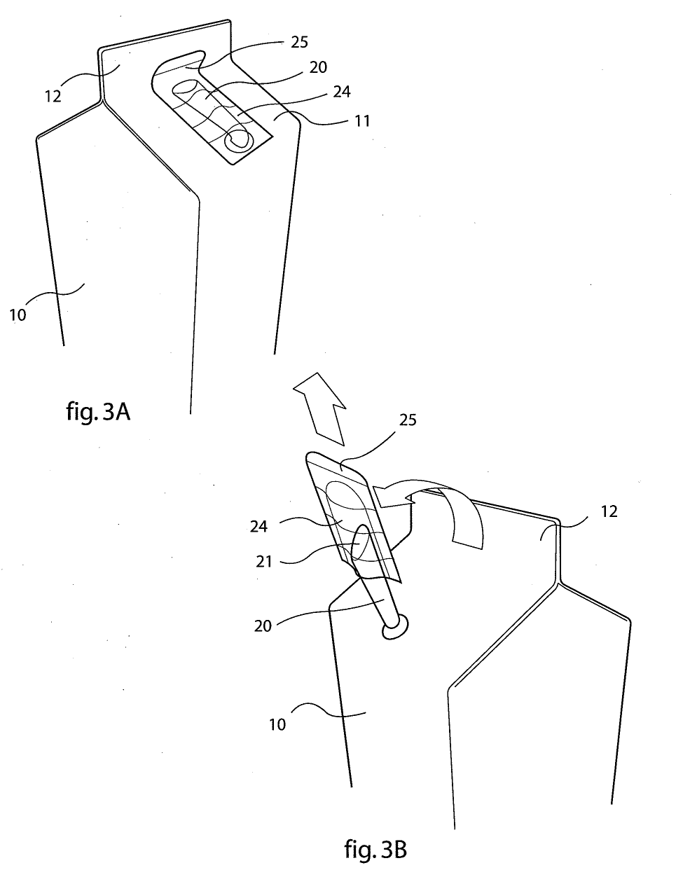

FIGS. 3A-3B show perspective views of a third embodiment of the pouring package according to the invention in respectively closed and opened position;

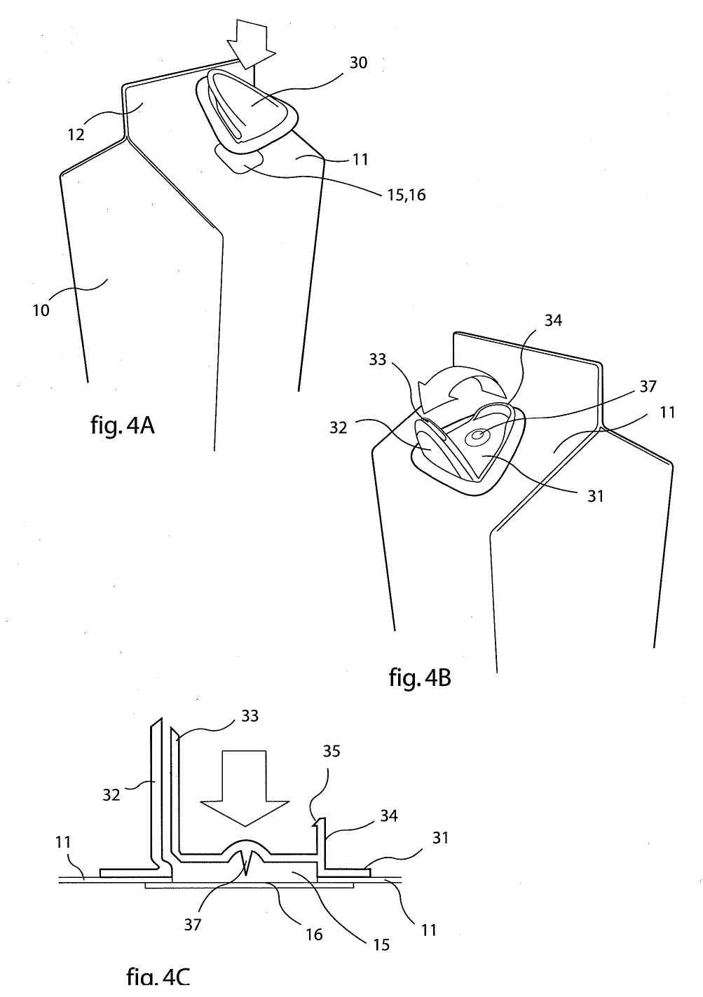

FIGS. 4A-4B show perspective views of a fourth embodiment of the pouring package according to the invention in respectively closed and opened position;

FIG. 4C shows a cross-section of the pouring member of the package of FIGS. 4A-B;

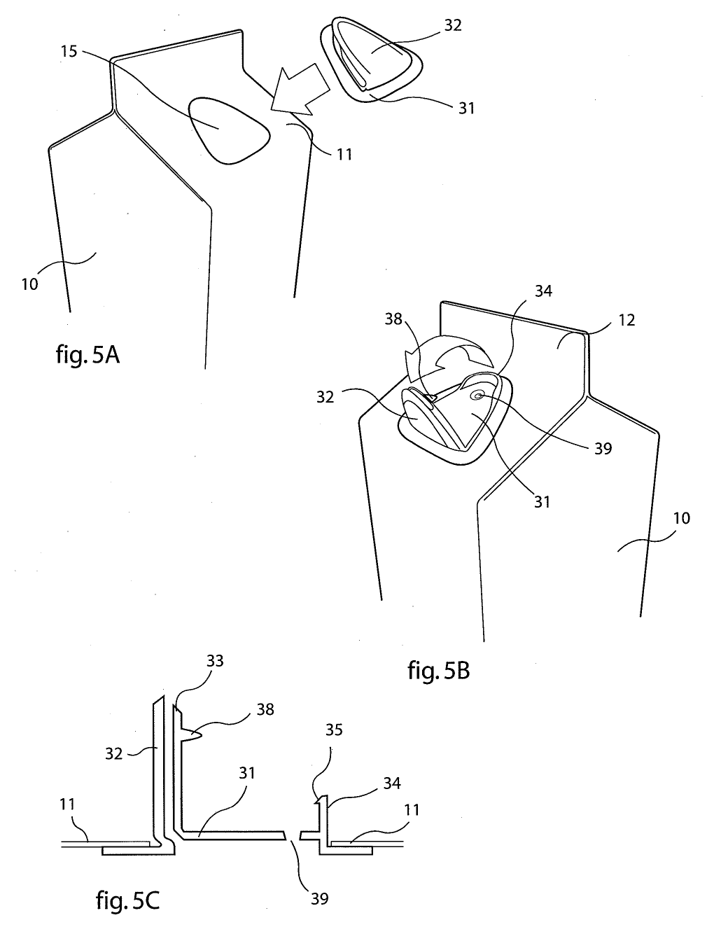

FIGS. 5A-5B show perspective views of a fifth embodiment of the pouring package according to the invention in respectively closed and opened position; and

FIG. 5C shows a cross-section of the pouring member of the package of FIGS. 5A-B.

The figures are otherwise purely schematic here and not drawn to scale. Some dimensions in particular may be exaggerated to a greater or lesser extent for the sake of clarity. Corresponding parts are designated as far as possible in the figures with the same reference numeral.

The package shown in FIGS. 1A and 1B comprises a container 10 of cardboard which is plasticized on an inner side with a suitable plastic coating in order to ensure a desired liquid-tightness. Such a package allows for fully automatic assembly and filling with conventional means in an industrial process. On a top side the container comprises a wall surface 11 with a closure 12. Arranged here in wall surface 11 is an outflow opening 15 where a pouring member 20 is provided for the purpose of enhancing pouring of a liquid received in a product space of the package.

In this example the pouring member comprises a substantially sleeve-like pouring body 20 having proximally an inlet, which is in register with outflow opening 15, and at a distal outer end an outlet 21 from which a liquid can exit freely from the package in a ready-to-use situation. Pouring body 20 is formed integrally from a suitable plastic such as polyethylene with a wall thickness of a fraction of a millimetre in order to impart a desired flexibility thereto. Internally the wall of the pouring member, otherwise not visible in the drawing, is profiled in mutually differing directions in order to ensure an unimpeded flow through the pouring member under all conditions.

In the closed situation shown in FIG. 1A pouring body 20 is attached relatively flat against wall surface 11 under an adhesive foil 22 provided for this purpose. The whole hereby retains a relatively flat profile which, in addition to being aesthetically attractive, is moreover practical during transport and processing in an automated industrial manufacturing and filling process. The pouring member can nevertheless be moved almost effortlessly into a practical ready-to-use position of FIG. 1B by grasping at a free outer end and peeling away the semi-adhering adhesive foil 22. The adhesive force of the adhesive foil is made smaller than the then exerted peeling force, so that foil 22 can be completely removed as one whole. The pouring member can then be freely erected, see FIG. 1B, after which it is possible to pour therewith as required or drink directly out of the package.

An alternative exemplary embodiment of the package according to the invention is shown in FIGS. 2A and 2B. The package is for the greater part the same as that of the previous example, although in this case the adhesive foil 22 is permanently connected to the container with an edge part 23, i.e. the adhesive force in this part is greater than the peeling strength due to a suitable choice of the adhesive layer differing at that position. The foil thus remains adhered to the package, see FIG. 2B, and does not detach from the container. The package can hereby be repeatedly reclosed by pivoting the pouring member back and fixing it under the semi-permanent adhesive foil. Moreover avoided here is that foil 22 is discarded separately into the environment.

FIGS. 3A and 3B show a further exemplary embodiment of the package according to the invention. This too is an embodiment which is largely similar to both the above described examples, although in this case the pouring member is adhered semi-permanently to wall surface 11 of the container by means of a foil sleeve 24. An improved and fully hygienic closure of pouring member 20 is thus achieved, and liquid possibly exiting from outlet 21 is prevented from being able to come into contact with the adhesive layer between foil 24 and wall surface 11, whereby the quality thereof would otherwise deteriorate. For enhanced convenience of use an edge part 25 of foil sleeve 24 is free of an adhesive layer in order to provide a freely accessible gripping part.

The exemplary embodiment shown in FIGS. 4A-4C makes use of a container similar to those of the foregoing examples but, in contrast to the above examples, comprises an at least substantially form-retaining pouring member 30. In this case use is also made for this purpose of a suitable plastic such as polyethylene, from which the pouring member can be assembled integrally, for instance by means of injection moulding. Pouring member 30 is mounted with a base part 31 against the wall surface and around outflow opening 15. In this example outflow opening 15 is closed separately by a hermetic breakable closure 16, see also FIG. 4C, such as for instance a (self-)adhesive aluminium foil or plastic foil arranged thereover, whereby the pouring member can, if desired, be arranged only after filling of the package and a sterile closure of the package is already guaranteed by breakable closure 16.

A hollow pouring spout 32 of the pouring member, with an outlet 33 at a distal outer end, is pivotable relative to the base part due to a suitable choice and dimensioning of the plastic applied. The pouring spout snaps into the closed position shown in FIG. 4A under a shoulder 35, provided for this purpose, of an edge part 34 of the base part, see also FIG. 4C, and thus retains a relatively flat profile with wall surface 11. The ready-to-use position shown in FIG. 4B is brought about by erecting the pouring spout 32. If desired, an optionally integrally formed breakable closure can be provided between the two parts 31,32 of the pouring member in order to prevent unwanted release of the pouring spout, and moreover as a visual indication that the package has been opened.

Situated in the pouring member is a perforating member 37 which depends from a flexible, at least compressible wall 36 of the base part and is directed toward the breakable closure 16 of outflow opening 15. Breakable closure 16 can thus be perforated from outside by exerting an appropriate pressure on wall 36, after which a liquid in the container can be poured via the pouring member. If desired, base part 31 can be embodied with a number of such perforating members in order to enlarge the overall perforated area and also to provide a venting opening. The above stated breakable closure between the base part and the pouring spout could also serve to prevent unwanted perforation of the foil, for instance during transport. After use the package can be reclosed by placing and snapping the pouring spout into the base part.

An alternative exemplary embodiment of a package according to the invention with a form-retaining pouring member is shown in FIGS. 5A-5B. This package is for the greater part the same as that of the previous example, although in this case the pouring member with base part 31 is arranged fittingly from inside through outflow opening 15 and attached against an inner side of wall surface 11, see FIG. 5C. An inlet of the pouring member is thus in direct connection with a product space in container 10. In this case also the pouring member comprises an outward pivotable pouring spout 32 with an outlet 33 which snaps into base part 31 in the closed position. Provided in the base part for the purpose of an unimpeded, controlled outflow of liquid is a venting opening 39 which in the closed position is at least substantially sealed with a closing member 38 extending from pouring part 32. Closing member 38 comprises a distally narrowing protrusion which here clamps fixedly into opening 39 and is optionally provided with a peripheral profiling for the purpose of snapping fixedly into the opening.

Although the invention has been further elucidated above on the basis of only several exemplary embodiments, it will be apparent that the invention is by no means limited thereto. On the contrary, many variations and embodiments are still possible for a person with ordinary skill in the art within the scope of the invention.

1. Pouring package for a liquid, comprising an at least substantially liquid-tight container with an outflow opening in a wall surface thereof, where a pouring member is arranged with an inlet which, at least in a ready-to-use situation, is in open communication with a product space in the container, and with an outlet on a distal outer end thereof at which a liquid can exit the product space, characterized in that at the position of the outflow opening the pouring member is connected liquid-tightly to an adjacent part of the wall surface, that in a closed position the pouring member is fixed at least substantially flat against the wall surface, and that at least the distal outer end of the pouring member can be erected into the ready-to-use position.

2. Pouring package as claimed in claim 1, characterized in that the pouring member comprises a sleeve-like body with a flexible wall and that attaching means are provided with which the sleeve-like body, at least in the closed position, is adhered at least substantially flat against the wall surface.

3. Pouring package as claimed in claim 2, characterized in that the attaching means comprise an adhesive foil under which the flexible body is received in a substantially flat position, wherein the adhesive foil extends outside the flexible body and adheres to an adjacent part of the wall surface.

4. Pouring package as claimed in claim 3, characterized in that a peripheral part of the foil is connected permanently to the container and the other part adheres semi-permanently to the wall surface.

5. Pouring package as claimed in claim 2, characterized in that the attaching means comprise a foil sleeve into which the pouring member protrudes with at least a distal outer end, wherein an underside of the foil sleeve adheres to the wall part.

6. Pouring package as claimed in claim 2, characterized in that the body comprises an inner wall which is profiled in a first direction on a first side and profiled in a second, different direction on an opposite side.

7. Pouring package as claimed in claim 2, characterized in that the sleeve-like body is formed integrally from a plastic, in particular from polyethylene, polystyrene, polycarbonate or PET.

8. Pouring package as claimed in claim 1, characterized in that the pouring member comprises an at least substantially form-retaining pouring body with a hollow pouring spout which is arranged pivotally relative to a base part thereof and which comprises the outlet, that the base part is connected adjacently of the outflow opening to the wall surface of the container and comprises the inlet, and that the base part comprises closing means which are able and adapted to enter into co-action with the pouring spout in order to effect a reclosable snap connection therebetween.

9. Pouring package as claimed in claim 8, characterized in that the closing means comprise an edge part of the base part with a shoulder which is directed toward the pouring spout and under which snaps a distal outer end of the pouring spout in the closed position.

10. Pouring package as claimed in claim 8, characterized in that the pouring member is attached against an inner side of the wall part and protrudes with the base part through the outflow opening.

11. Pouring package as claimed in claim 8, characterized in that the outflow opening is hermetically closed with a breakable closure and that the pouring member is arranged over the breakable closure on an outer side of the wall part.

12. Pouring package as claimed in claim 11, characterized in that the base part of the pouring member opposite the breakable closure comprises a wall, from which extends at least one perforating member directed toward the breakable closure, wherein the at least one perforating member is able and adapted to break through the breakable closure under the influence of a pressure applied externally to the wall.

13. Pouring package as claimed in claim 8, characterized in that the base part comprises a venting opening and that from the pouring spout there extends a closing member which is able and adapted to enter the venting opening fittingly in the closed position of the pouring spout.

14. Pouring package as claimed in claim 13, characterized in that the closing member comprises a protrusion which snaps into the venting opening.

15. Pouring member for use in the pouring package as claimed in claim 1.

16. Pouring package as claimed in claim 9, characterized in that the pouring member is attached against an inner side of the wall part and protrudes with the base part through the outflow opening.

17. Pouring package as claimed in claim 9, characterized in that the outflow opening is hermetically closed with a breakable closure and that the pouring member is arranged over the breakable closure on an outer side of the wall part.
